(19) United States
(12) Patent Application Publication
(10) Pub. No.: US 2015/0091907 A1
(43) Pub. Date: Apr. 2, 2015

(54) METHOD AND SYSTEM FOR STORING WAVEFORM DATA

(71) Applicant: BYTE PARADIGM SPRL, WAVRE (BE)

(72) Inventors: Didier Martiny, Ceroux Mousty (BE); Frederic Leens, Woluwe Saint Pierre (BE); Olivier Rasmont, Dongelberg (BE)

(73) Assignee: BYTE PARADIGM SPRL, WAVRE (BE)

(21) Appl. No.: 14/039,829

(22) Filed: Sep. 27, 2013

(51) Int. Cl. G06T 11/20

(52) U.S. Cl. CPC G06T 11/206; G06T 2210/36
USPC 345/428; 345/440.1

(57) ABSTRACT

The method of the invention comprises the steps of: receiving waveform data (100); generating one main signal Y₀; saving main data related to main signal Y₀; defining an input signal to fold, Yᵢₙ, that is said main signal Y₀ or a folded signal that has been generated just before; generating a new folded signal, Y_{f}, that is a global reproduction of lower resolution of input signal to fold, Yᵢₙ, and that has less samples than the latter by performing the steps of: applying to whole input signal to fold, Yᵢₙ, a folding algorithm such that: its samples satisfying folding rules are selected; its samples not satisfying said folding rules are deleted; thereafter grouping the selected samples for forming said new folded signal Y_{f}; saving sub data related to said folded signal Y_{f}.

### TECHNICAL FIELD

The present invention relates to a method for storing waveform data. More specifically and according to a first aspect, the present invention relates to a method for storing, from waveform data, useful information allowing an efficient use of a waveform viewer. According to a second aspect, the invention relates to a device for storing, from waveform data, useful information for a waveform viewer.

### DESCRIPTION OF PRIOR ART

A waveform viewer is used to visualize waveform data. Waveform data is generally composed of a series of values representing the evolution of the amplitude of at least one variable according to a parameter that is for example and most frequently, the time. Waveform data may originate for instance from measurements performed on circuits or data extracted from circuit design, or from Electronic Design Automation (EDA) tool performing circuit design simulation.

Generally, the entire set of waveform data is too voluminous to fit on the display area of a waveform viewer. The display area of the waveform viewer has only a limited number of pixels available to display waveform, which is defined by the dimensions and pixel resolution of the viewing window of the waveform viewer. Generally, the waveform viewer may be controlled by a user to display all or part(s) of the overall waveform. The user may zoom in or out to view the full or partial waveform at different levels of resolution. It is likely that only a limited portion of the entire waveform data may be displayed at any moment in time in the waveform viewer. Therefore, it is not required to send the entirety of the voluminous waveform data to the waveform viewer when only a smaller subset is to be displayed.

The method disclosed in U.S. Pat. No. 8,325,188 addresses some of these problems. According to this method, waveform data is first segmented to break the entire set of waveform data into smaller portions or segments. Next, these segments are compressed. Various compressor mechanisms can be employed. Next action is to index the segmented and multiple levels of resolution of waveform data. The index data allows the system to identify and access the appropriate waveform data for the required resolution level to be displayed at the waveform viewer.

This method presents several drawbacks. When a user wants to display a long part of a signal originating from the waveform data, it is necessary to first reassemble the different segments that have been generated and saved in order to get said long part of the signal that is desired by the user for display. Hence, this method leads to an access of useful information that is not simple: one needs to reassemble the different segments that have been generated and saved in order to get the useful and wanted information. Moreover, this way of saving information from waveform data is not well-adapted to the different levels of screen resolution that are selected by a user of a waveform viewer. Therefore, this method of saving information from waveform data is not efficient enough for a later display of data related to this waveform data at a waveform viewer.

### SUMMARY OF THE INVENTION

According to a first aspect, it is an object of the invention to provide a method for storing useful information from waveform data that provides a simpler later access of this information and that is more efficient for displaying data related to this waveform data at a waveform viewer. To this end, the inventors propose the following method.

Method for storing, from waveform data, useful information for a waveform viewer and comprising the steps of:
(i) receiving said waveform data;
(ii) generating from this waveform data one main signal Y₀ having N₀ samples, Y₀(i) i=1, . . . N₀, that are N₀ values of said main signal Y₀ at N₀ values of a reference signal, X;
(iii) saving main data related to said main signal Y₀;
(iv) defining an input signal to fold, Yᵢₙ, that is:
   if no folded signal originating from said main signal Y₀ has been generated before, said main signal Y₀,
   else, a folded signal originating from said main signal Y₀ that has been generated just before;
(v) generating a folded signal Y_{f}:
   that is a global reproduction of lower resolution of said input signal to fold, Yᵢₙ,
   that has N_{f} samples that are N_{f} values of said folded signal Y_{f} at N_{f} values of said reference signal, X, and
   that has less samples than said input signal to fold, Yᵢₙ, by carrying out the following steps:
a) applying to substantially the whole of said input signal to fold, Yᵢₙ, a folding algorithm such that:
   samples of said input signal to fold, Yᵢₙ, satisfying folding rules are selected;
   samples of said input signal to fold, Yᵢₙ, not satisfying said folding rules are deleted;
b) thereafter grouping the samples selected in step a) for forming said folded signal Y_{f};
(vi) saving sub data related to said folded signal Y_{f};
(vii) optionally repeating steps (iv) to (vi).

The words ‘useful information for a waveform viewer’ mean information that can be used by a waveform viewer in order to provide to a user of such a waveform viewer relevant information. Relevant information means for instance information that could help a user to know if an electronic circuit works correctly. With the method of the invention, different folded signals, Y_{f}, are generated. Each folded signal, Y_{f}, is a reproduction of the whole (or global) main signal, Y₀, as each folded signal, Y_{f}, is a reproduction of lower resolution of substantially the whole of each input signal to fold, Yᵢₙ. And, this input signal to fold, Yᵢₙ, is the main signal, Y₀, in the beginning of the iterative process. In other words, the whole wrapper (or whole envelope) of the different input signals to fold, Yᵢₙ, and hence, of the main signal, Y₀, is preserved when generating the different folded signals, Y_{f}. Hence, contrary to the method of U.S. Pat. No. 8,325,188, a signal of interest is not divided in segments for storing purposes with the method of the invention. The entire wrapper of the main signal Y₀ is considered and kept at each folding level. The different folding levels relate to the different generated folded signals, Y_{f}. Hence, contrary to the method of U.S. Pat. No. 8,325,188, it is not necessary to reassemble different segments in order to visualize a whole signal (no segment of such a signal is generated). Finally, the method of the invention is simpler for a latter access of relevant information, such as data related to a whole signal.

Main data related to main signal, Y₀, and sub data related to the different folded signals, Y_{f}, that are saved in steps (iii) and (vi) can be used for display with minimal reconstruction operations with the method of the invention. Depending on the limits and on the resolution of the window that is selected by a user of a waveform viewer, it is possible to determine a number of pixels that are available for displaying a signal between these limits. Thereafter, it is possible for a computer unit for instance to chose the folded signal, Y_{f}, (or the main signal Y₀) that is more adapted for displaying the signal between these limits. No additional decompression step is necessary. Data saved can be used for display with minimal reconstruction operations. As a consequence, the method of the invention is more efficient for displaying data related to waveform data at a waveform viewer.

The method of the invention has other advantages. As each folded signal, Y_{f}, has same main wrapper as main signal, Y₀, a global picture of a signal can always be displayed and is always available for the user. This facilitates fast global analysis of a signal. And thereafter, useful information can be found more easily and more rapidly by a user of a waveform viewer. With the method of the invention, waveform data is encoded such that access and transfer of excessive data beyond what is actually needed for display are minimized.

Preferably, main data related to said main signal, Y₀, is saved in a main data file in step (iii). Preferably, sub data related to said folded signal, Y_{f}, is saved in a sub data file in step (vi)

Preferably, said N₀ samples of said main signal Y₀ represent amplitudes of a digital signal. Then, the samples of the folded signals are also amplitudes of a digital signal.

Preferably, said N₀ samples of said main signal Y₀ represent amplitudes of an analog signal. Then, the samples of the folded signals are also amplitudes of an analog signal.
Preferably, said main signal Y₀ represents a combination of signals comprised in said waveform data. This preferred embodiment presents notably the following advantages: clarity, and readability of information that is thereafter displayed on a waveform viewer. Such a preferred embodiment is preferably used when dealing with digital signals. Combination of bits allows forming a bus. A digital signal can then be transformed in an analog signal to which min/max algorithms can be applied.

Preferably, said main signal Y₀ is generated by using a transition detection method such that it mainly contains information about transitions. Said transition detection method can be compared to Value Change Dump (VCD) method that is known by the one skilled in the art. With said transition detection method, transitions are first detected. Thereafter, only data linked to these detected transitions is selected in order to generate main signal Y₀. By using this preferred embodiment, the size of main signal, Y₀, can be reduced, as well as the size of the preferred main data file, of the folded signals Y_{f}, and of the preferred sub data files.

Preferably, said main data related to said main signal Y₀ is saved in step (iii) by using a method that records transitions. This method can be compared to a VCD-like method. In this preferred embodiment, main signal Y₀ is preferably a signal extracted from the waveform data or more preferably a combination of signals extracted from the waveform data. By storing (or saving) the main data of step (iii) according to a such a preferred method, it is possible to reduce the size of the main data file when such a main data file is used. More generally, it is then possible to reduce the memory size needed for saving main data related to main signal, Y₀. Preferably, sub data related to the folded signals, Y_{f}, is also saved in step (vi) by using same method. Then, the size of the sub data file(s) can also be reduced when such sub data file(s) are used. More generally, it is then possible to reduce the memory size needed for saving sub data related to sub signal(s), Y_{f}. Preferably, temporal information is also saved in addition to information related to transitions. More preferably, values of time intervals during which main signal, Y₀, or folded signals, Y_{f}, are constant are saved with a first value of said main signal, Y₀, or a first value of said folded signals, Y_{f}, of such time intervals. Then, it is easier to reconstruct main signal, Y₀, or folded signals, Y_{f}, from information related to the transitions.

Preferably, said folding algorithm comprises the following steps:
dividing said input signal to fold, Yᵢₙ, in portions, each portion comprising substantially Nₚ successive samples of said input signal to fold, Yᵢₙ, Nₚ≧3;
for each of said portions applying the following steps for selecting two samples in each of said portions:
   one sample whose absolute value is equal to or larger than the other samples is selected,
   another sample whose absolute value is equal to or smaller than the other samples is selected, and
   the other samples are deleted.
      Nₚ is an integer. Nₚ is lower than the number of samples of the input signal to fold, Yᵢₙ. Each portion comprises substantially Nₚ successive samples of the input signal to fold, Yᵢₙ. This means that few portions (for instance one, two, or three) could comprise less or more samples as it is not always possible to divide the input signal to fold, Yᵢₙ, in portions that all comprise Nₚ successive samples.
      This preferred embodiment is particularly well-adapted when dealing with analog signals or data related to analog signals.

Preferably, said folding algorithm comprises the following steps:
dividing said input signal to fold, Yᵢₙ, in portions, each portion comprising substantially Nₚ successive samples of said input signal to fold, Yᵢₙ, Nₚ≧3;
for each of said portions applying the following steps for selecting two samples in each of said portions:
   sample Yᵢₙ(q) with lowest index q is selected;
   sample Yᵢₙ(p) with highest index p is selected;
   the other samples are deleted.
      Nₚ is an integer. Nₚ is lower than the number of samples of the input signal to fold, Yᵢₙ. Each portion comprises substantially Nₚ successive samples of the input signal to fold, Yᵢₙ. This means that few portions (for instance one, two, or three) could comprise less or more samples as it is not always possible to divide the input signal to fold, Yᵢₙ, in portions that all comprise Nₚ successive samples.
      This preferred embodiment is particularly well-adapted when dealing with digital signals or data related to digital signals.

Preferably, said folding algorithm comprises the following steps:
dividing said input signal to fold, Yᵢₙ, in portions, each portion comprising substantially Nₚ successive samples of said input signal to fold, Yᵢₙ, Nₚ≧3;
for each of said portions applying the following steps for selecting one sample in each of said portions:
detecting if a transition occurs among the successive samples of the portion;
if yes, one sample Yᵢₙ(b) of the portion is selected, where b is neither the lowest nor the highest index in the portion, the other samples of the portion are deleted;
if no, no sample is selected.
   Nₚ is an integer. Nₚ is lower than the number of samples of the input signal to fold, Yᵢₙ. Each portion comprises substantially Nₚ successive samples of the input signal to fold, Yᵢₙ. This means that few portions (for instance one, two, or three) could comprise less or more samples as it is not always possible to divide the input signal to fold, Yᵢₙ, in portions that all comprise Nₚ successive samples.
   This preferred embodiment is particularly well-adapted when dealing with digital signals or data related to digital signals. Preferably, a transition is detected by comparing amplitudes of two successive samples. If two successive samples have different amplitudes, one can conclude that a transition takes place. Otherwise, there is no transition.

Preferably, the method of the invention also allows accessing said useful information for displaying it at a waveform viewer, and further comprising the steps of:
providing a range, ΔX, of said reference signal, X;
providing a width of a display window of said waveform viewer (200);
providing a number of pixels, Nₚᵢₓ, available for display in said width of said display window;
among said main signal, Y₀, and among said folded signals, Y_{f}, choosing one of them having in said range, ΔX, of said reference signal, X, a number of samples closest to said number of pixels, Nₚᵢₓ.
   This preferred embodiment of the method of the invention also allows accessing said useful information for displaying it at waveform viewer. By using such a method, the access of useful information is more efficient than other methods known by the one skilled in the art.

Preferably, the method of the invention also allows accessing said useful information for displaying it at a waveform viewer, and further comprising the steps of:
providing a range, ΔX, of said reference signal, X;
providing a width of a display window of said waveform viewer;
providing a number of pixels, Nₚᵢₓ, available for display in said width of said display window;
among said main signal, Y₀, and among said folded signals, Y_{f}, choosing one of them having in said range, ΔX, of said reference signal, X, a number of samples equal to or larger than said number of pixels, Nₚᵢₓ.

Preferably, said main data related to said main signal, Y₀, is saved in a main data file in step (iii), said main data file comprising at least one element comprising an n-th value of said reference signal, X(n), and a value of a sample, Y₀(n), of said main signal at said n-th value of said reference signal, X.

Retrieving a sample of the main signal, Y₀, corresponding to a given value of the reference signal, X, is more easy and more rapid with this preferred embodiment. This preferred embodiment of the method of the invention is therefore more efficient. A comparison of said given value of the reference signal, X, with said n-th value of said reference signal, X(n), can indeed be carried out in order to quickly identify into which part(s) of the main data file the sample of main signal, Y₀, corresponding to said given value of the reference signal, X, is located.

Preferably, said sub data related to said folded signal, Y_{f}, is saved in a sub data file in step (vi), said sub data file comprising at least one element comprising an n-th value of said reference signal, X(n), and a value of a sample, Y_{f}(n), of said folded signal at said n-th value of said reference signal, X.

Retrieving a sample of a folded signal, Y_{f}, corresponding to a given value of the reference signal, X, is more easy and more rapid with this preferred embodiment. This preferred embodiment of the method of the invention is therefore more efficient. A comparison of said given value of the reference signal, X, with said n-th value of said reference signal, X(n), can indeed be carried out in order to quickly identify into which part(s) of the sub data file(s) the sample of said folded signal, Y_{f}, corresponding to said given value of the reference signal, X, is located.

According to a second aspect, the invention relates to a device for storing, from waveform data, useful information for a waveform viewer and comprising:
input means for receiving waveform data;
processing means for generating from this waveform data one main signal Y₀ having N₀ samples, Y₀(i) i=1, . . . N₀, that are N₀ values of said main signal Y₀ at N₀ values of a reference signal, X;
saving means for saving main data related to said main signal Y₀;
pre-processing means for defining an input signal to fold Yᵢₙ, that is:
   if no folded signal originating from said main signal Y₀ has been generated before, said main signal Y₀,
   else, a folded signal originating from said main signal Y₀ and that has been generated just before;
processing means for carrying out the following steps:
   a) applying to substantially the whole of said input signal to fold, Yᵢₙ, a folding algorithm such that:
      samples of said input signal to fold, Yᵢₙ, satisfying folding rules are selected;
      samples of said input signal to fold, Yᵢₙ, not satisfying said folding rules are deleted;
   b) thereafter grouping the samples selected in step a) for forming said folded signal Y_{f};
for generating a folded signal Y_{f}
   that is a global reproduction of lower resolution of said input signal to fold, Yᵢₙ,
   that has N_{f} samples that are N_{f} values of said folded signal Y_{f} at N_{f} values of said reference signal, X, and
   that has less samples than said input signal to fold, Yᵢₙ;
saving means for saving sub data related to said folded signal Y_{f}.

Preferably, said pre-processing means, said processing means, and said saving means are able to run iteratively in order to define successive input signals to fold, Yᵢₙ, in order to generate successive folded signals, Y_{f}, and in order to save such successive folded signals, Y_{f}.

Preferably, said successive folded signals, Y_{f}, are saved in different sub data files.

Preferably, the device of the invention further comprises an accessing unit for choosing among said main signal, Y₀, and among said folded signals, Y_{f}, one of them having in a range, ΔX, of said reference signal, X, a number of samples that is closest to a number of pixels, Nₚᵢₓ, available in a width of a display window of a waveform viewer.

Preferably, said main data related to said main signal Y₀ is saved in a main data file.

### BRIEF DESCRIPTION OF THE DRAWINGS

These and further aspects of the invention will be explained in greater detail by way of example and with reference to the accompanying drawings in which:

FIG. 1 notably shows a flowchart illustrating main steps of the method of the invention;

FIG. 2 shows an example of a digital main signal and a corresponding folded signal;

FIG. 3 shows an example of an analog main signal and a corresponding folded signal;

FIG. 4 shows an example of a preferred sub data file;

FIG. 5 shows a preferred embodiment of the device of the invention;

FIG. 6 shows another preferred embodiment of the device of the invention.

The drawings of the figures are neither drawn to scale nor proportioned. Generally, identical components are denoted by the same reference numerals in the figures.

### DETAILED DESCRIPTION OF A PREFERRED EMBODIMENT

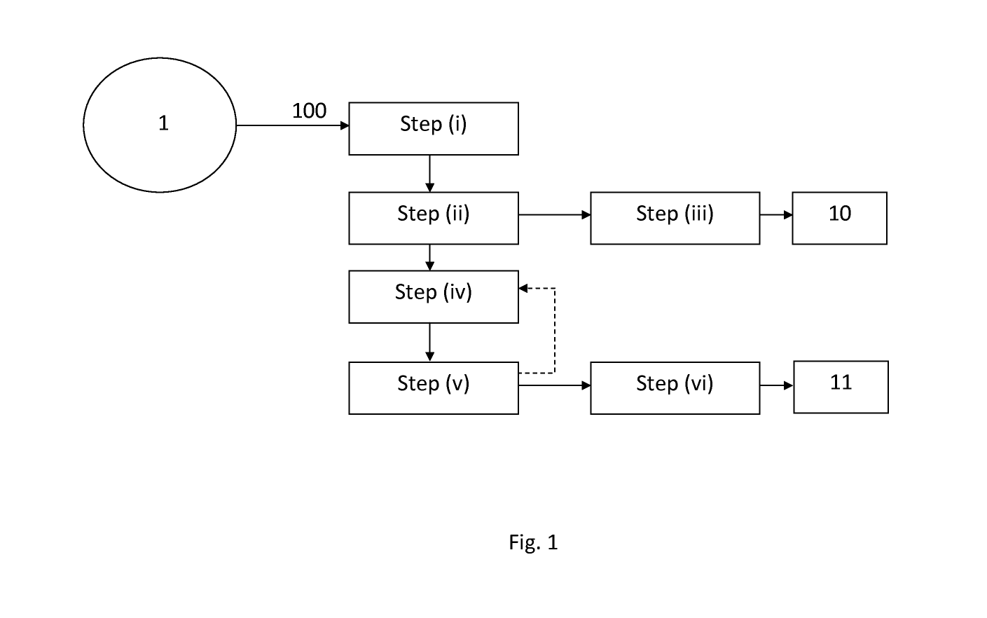

FIG. 1 shows a flowchart illustrating main steps of the method of the invention. First step (step (i)) is receiving waveform data 100. Waveform data 100 may originate from measurements performed on circuits or data extracted from circuit design, or, for example, from EDA tool performing circuit design simulation (EDA tools are known by the one skilled in the art). Waveform data 100 is generally composed of a series of values representing evolution of amplitude of at least one variable according to a parameter that is for example, the time. In what follows, this parameter is named reference signal, X. This reference signal, X, is preferably a clock signal known by the one skilled in the art. Preferably, waveform data 100 comprises one or more physical signals such as temporal evolutions of voltages, current across electronic devices. In the general flowchart shown in FIG. 1, waveform data 100 originates from a data source 1 (that is for instance an EDA tool, or a unit transmitting results of measurements).

In a second step (step (ii)), one main signal, Y₀, is generated from this waveform data 100. This main signal, Y₀, has N₀ samples: Y₀(i) i=1, . . . N₀, where N₀ is an integer. These N₀ samples of the main signal, Y₀, are N₀ values of said main signal Y₀ at N₀ values of the reference signal, X. Main signal, Y₀, can be of various types. When waveform data 100 comprises evolutions of different signals with respect to the reference signal, X, main signal, Y₀, can be one of these different signals. Main signal, Y₀, can also be a combination of various signals included in the waveform data 100. Such various signals can have various numbers of samples corresponding to various reference signals, X. For instance, one can have a first signal YY₁ included in the in the waveform data 100 corresponding to a first reference signal, XX₁, and a second signal YY₂ included in the in the waveform data 100 and corresponding to a second reference signal, XX₂. And, XX₁ and XX₂ are different in a general case. Then, it is possible to generate a main signal, Y₀, by combining YY₁ and YY₂. Then, one preferably first defines a common (or shared) reference signal, X, having a higher resolution (or a higher number of values) than XX₁ and XX₂.

Methods known by the one skilled in the art can be used for generating a main signal, Y₀ that is a combination of various signals included in the waveform data 100: for instance, one can add two measured signals. Other examples of the main signal, Y₀, are presented below.

Once the main signal, Y₀, has been generated, data related to it are saved, preferably in a main data file 10: this is step (iii). The whole main signal, Y₀, can be saved in the main data file 10. Preferably, specific methods are used for saving the main signal, Y₀, in order to lower the size of the needed memory. This is particularly interesting when the main signal, Y₀, represents a whole signal of the waveform data 100, that means a signal that has not been subjected to any methods for lowering its size. Then, the whole main signal, Y₀, is preferably not saved. Data related to this main signal, Y₀, is then rather saved. A transition detection method that can be compared to Value Change Dump (VCD) is preferably used for generating such data related to this main signal, Y₀,and that is saved. VCD is known by the one skilled in the art.

Steps (iv)-(vi) are preferably repeated in an iterative way in order to generate different folded signals, Y_{f}. However, only one iteration could be applied such that only one folded signal, Y_{f}, is generated. A folded signal, Y_{f}, is a global reproduction (or duplication) of lower resolution of an input signal to fold, Yᵢₙ. At the first iteration, input signal to fold, Yᵢₙ, is the main signal, Y₀. Thereafter, input signal to fold, Yᵢₙ, is a folded signal, Y_{f}, that has been generated in previous iteration. Each folded signal, Y_{f}, has N_{f} samples that are N_{f} values of it at N_{f} values of the reference signal, X. At each successive iteration, N_{f} is lower. Each folded signal, Y_{f}, has less samples that the input signal to fold, Yᵢₙ, from which it is generated. Each folded signal, Y_{f}, is generated in step (v) by applying to substantially the whole of the input signal to fold, Yᵢₙ, a folding algorithm. The word substantially means here that the folding algorithm is applied to at least 80%, or preferably at least 90% of samples of said input signal to fold, Yᵢₙ. More preferably, the folding algorithm is applied to 95% of the samples of the input signal to fold, Yᵢₙ. Still more preferably, the folding algorithm is applied to all the samples of the input signal to fold, Yᵢₙ. As a result of the folding algorithm, samples of the input signal to fold, Yᵢₙ, satisfying folding rules are selected, whereas samples of the input signal to fold, Yᵢₙ, not satisfying folding rules are deleted. By grouping the samples that are selected by the folding algorithm, a new folded signal, Y_{f}, can be obtained. For illustrative purposes, let us consider an academic example. Let us assume that input signal to fold, Yᵢₙ, is the main signal, Y₀, that has N₀ samples: Y₀(1), . . . , Y₀(10), . . . , Y₀(N₀). If samples Y₀(1), Y₀(10), and Y₀(N₀), are selected by the folding algorithm, then, the folded signal Y_{f} generated from the main signal, Y₀, has the following samples: Y₀(1), Y₀(10), Y₀(N₀). In this case, N_{f}=3.

The inventors propose various folding algorithms for generating a folded signal, Y_{f}, that is a global reproduction of lower resolution of the input signal to fold, Yᵢₙ, and that has less samples than said input signal to fold, Yᵢₙ. Some examples are given below. At step (vi), sub data related to the folded signal, Y_{f}, that has been generated is saved, preferably in a sub data file 11. As discussed above in relation to the main data file 10, different ways for saving sub data can be used. Raw folded signals, Y_{f}, can be saved or preferably data related to said folded signals, Y_{f}, is saved when it is desired to reduced the size of the needed memory. A VCD-like method can be used for instance for saving data related to the folded signals, Y_{f}.

Preferably, main data is saved by using a compression algorithm. More preferably, one of the following compression algorithms is used: ZIP (dictionary algorithm), Zlib, LZMA, libzip, mimiz. Preferably, sub data is saved by using a compression algorithm. More preferably, one of the following compression algorithms is used: ZIP (dictionary algorithm), Zlib, LZMA, libzip, mimiz.

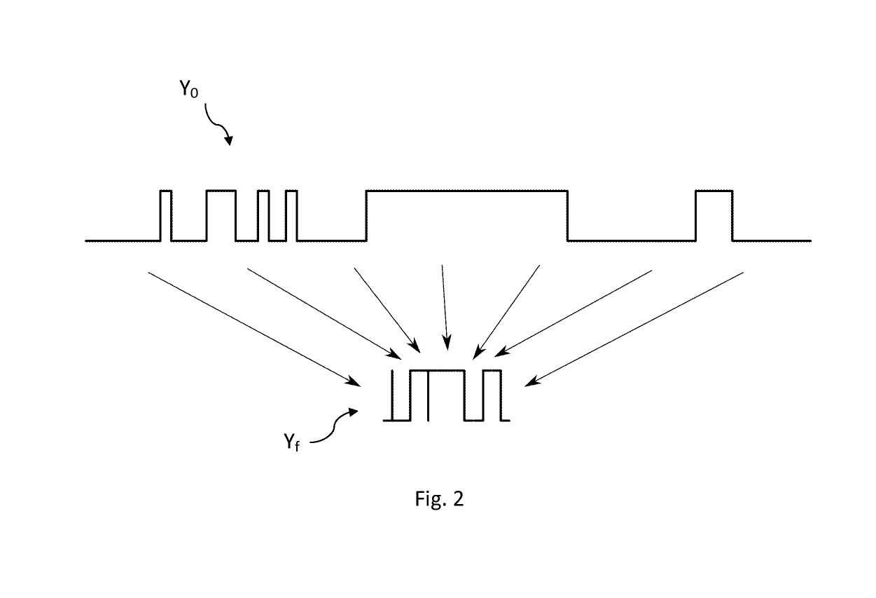

FIG. 2 shows an illustrative example of a main signal, Y₀, and of a folded signal, Y_{f}, generated with the method of the invention when the main signal, Y₀, is a digital signal. From this figure, we see that the global wrapper of main signal, Y₀, is kept in the folded signal, Y_{f}.

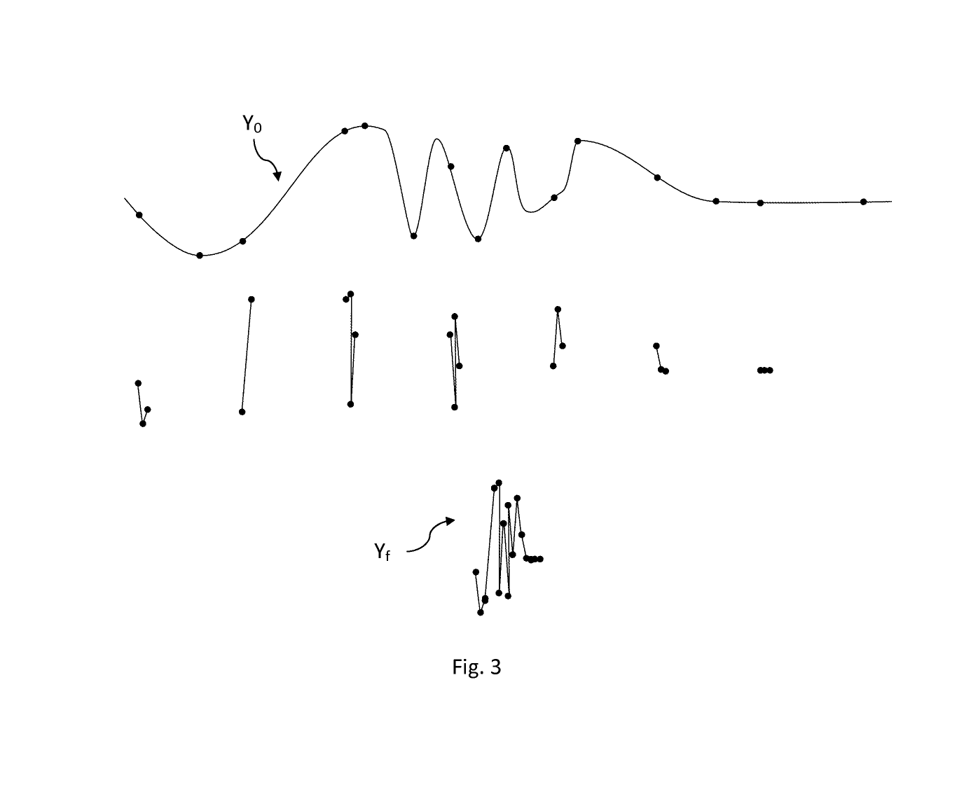

FIG. 3 shows another illustrative example of a main signal, Y₀, and of a folded signal, Y_{f}, generated with the method of the invention when the main signal, Y₀, is an analog signal. Middle part of FIG. 3 shows samples of main signal, Y₀, that are selected by the folding algorithm.

In a preferred embodiment, main signal, Y₀, is a reproduction (or a picture) of a signal of the waveform data 100. That means for instance that some mathematical operations can be applied to a signal of the waveform data 100 in order to generate the main signal, Y₀. Preferably, main signal, Y₀, is generated by using a transition detection method such that said main signal, Y₀, mainly contains information about transitions. This transition detection method can be compared to Value Change Dump (VCD) method that is known by the one skilled in the art. If a transition is detected, corresponding sample of the signal is selected for generating the main signal, Y₀. If no transition is detected, then, index number indexing the different samples of the signal is simply incremented without storing any sample of the signal. Hence, this preferred method only stores transitions. Various methods known by the one skilled in the art can be used for detecting transitions. When dealing with digital signal, a transition is easy to detect as it represents change from 0 to 1 or from 1 to 0. As detailed below, when a transition detection method is used for generating main signal, Y₀, temporal information such as time interval during which main signal, Y₀, is constant is preferably also used for generating said main signal, or for defining said main data that is saved in step (iii). Then, even if only information about transitions is first selected, ‘real’ signal can thereafter be easily reconstruct from such temporal information.

Different folding algorithms are now presented. They can be used alone or in combination for generating the folded signals, Y_{f}. According to a first preferred example, such a folding algorithm comprises the following steps:
dividing the input signal to fold, Yᵢₙ, in portions, each portion comprising substantially Nₚ successive samples of said input signal to fold, Yᵢₙ, Nₚ≧3;
for each of said portions applying the following steps for selecting two samples in each of said portions:
one sample whose absolute value is equal to or larger than the other samples is selected,
another sample whose absolute value is equal to or smaller than the other samples is selected, and
the other samples are deleted.

According to a second preferred example, the folding algorithm comprises the following steps:
dividing the input signal to fold, Yᵢₙ, in portions, each portion comprising substantially Nₚ successive samples of said input signal to fold, Yᵢₙ, Nₚ≧3;
for each of said portions applying the following steps for selecting two samples in each of said portions:
sample Yᵢₙ(q) with lowest index q is selected;
sample Yᵢₙ(p) with highest index p is selected;
the other samples are deleted.
   Therefore, this second preferred example corresponds to a method that selects first and last sample of each portion.

According to a third preferred example, the folding algorithm comprises the following steps:
dividing said input signal to fold, Yᵢₙ, in portions, each portion comprising substantially Nₚ successive samples of said input signal to fold, Yᵢₙ, Nₚ≧3;
for each of said portions applying the following steps for selecting one sample in each of said portions:
   detecting if a transition occurs among the successive samples of the portion;
      if yes, one sample Yᵢₙ(b) of the portion is selected, where b is neither the lowest nor the highest index in the portion, the other samples of the portion are deleted;
      if no, no sample is selected.
         Preferably, a transition is detected by comparing two successive samples. If the amplitude of two successive samples changes, then, one can deduce that a transition occurs. Otherwise, there is no transition.

Preferably, first and second preferred examples for the folding algorithm that have been described above are used in combination. More preferably, first, second, and third preferred examples for the folding algorithm that have been described above are used in combination.

For each of these three preferred examples, when the input signal to fold, Yᵢₙ, comprises 1024 samples, it is preferably divided in 64 portions, each portion comprising substantially Nₚ=16 successive samples.

By grouping the N_{f} different samples of Yᵢₙ that have been selected by the folding algorithm, folded signal, Y_{f}, can be finally obtained, preferably by using the following preferred procedure:
first sample of the folded signal, Y_{f}(1), corresponds to the selected sample of Yᵢₙ with the lowest index: Y_{f}(1)=Yᵢₙ(k), where k is the lowest index among the indices of the samples of Yᵢₙ that have been selected by the folding algorithm;
last sample of the folded signal, Y_{f}(N_{f}), corresponds to the selected sample of Yᵢₙwith the highest index: Y_{f}(N_{f})=Yᵢₙ(m), where m is the highest index among the indices of the samples of Yᵢₙ that have been selected by the folding algorithm;
the other N_{f}−2 selected samples of Yᵢₙ are organized between Y_{f}(1)=Yᵢₙ(k) and Y_{f}(N_{f})=Yᵢₙ(m) such that indices j of these selected samples of Yᵢₙ monotonically increase between k and m.
   k and m are integers.

According to another preferred embodiment, the method of the invention is also able to access the useful information stored from the waveform data 100 for displaying it at a waveform viewer 200. A waveform viewer 200 is known by the one skilled in the art. This preferred embodiment comprises the following preferred steps:
providing a range, ΔX, of the reference signal, X, between a minimum value, Xₘᵢₙ, and a maximum value, Xₘₐₓ, ΔX=Xₘₐₓ−Xₘᵢₙ (this step is preferably carried out by a user selecting a region of interest, preferably by using a pointing device such as a mouse);
providing a width of a display window of said waveform viewer 200;
providing a number of pixels, Nₚᵢₓ, available for display in said display window (preferably, Nₚᵢₓ corresponds to a number of pixels along a horizontal direction);
among the main signal, Y₀, and among the folded signals, Y_{f}, that have been generated by the method of the invention, choosing one of them having a number of samples in said range, ΔX, of said reference signal, X, that has a number of samples that is closest to said number of pixel, Nₚᵢₓ.

According to another preferred embodiment, this last step can be replaced by:
among the main signal, Y₀, and among the folded signals, Y_{f}, that have been generated by the method of the invention, choosing one of them having a number of samples in said range, ΔX, of said reference signal, X, that has a number of samples that is equal to or larger than said number of pixel, Nₚᵢₓ.
   In this last preferred case, it is thus possible that the signal selected for display has more samples than Nₚᵢₓ. Then, the following display procedure is preferably followed: several samples of the selected signal are displayed with a same (horizontal) pixel along the width of the display window of the waveform viewer 200.

Hence, according to these preferred embodiments that have been described in previous paragraph, it is possible to access more easily the signal that is the most adapted for the display window selected by a user. Such an easy access is notably possible thanks to the specific generations and savings of main, Y₀, and folded signals, Y_{f}. For choosing the most adapted signal among Y₀ and the different Y_{f}, one has to determine the number of samples in each of these signals, Y₀ and the different Y_{f}, in the range ΔX. One can then determine a difference value for each signal, Y₀ and the different Y_{f}, that is the difference between Nₚᵢₓ and the numbers of samples of each of these signals in the range ΔX. A signal with the smallest difference value is selected. As the number of samples of the selected signal is not in general equal to Nₚᵢₓ, a processing step is in general thereafter applied in order to have a value of the selected signal at each pixel of the display window. Interpolation that is known by the one skilled in the art is preferably applied when the selected signal has less samples than Nₚᵢₓ.

According to another preferred embodiment, main data related to main signal, Y₀, that is saved in step (iii), and sub data related to each folded signal, Y_{f}, that is saved in step (vi), comprise temporal information. For instance, when Y₀ and Y_{f} are saved with a VCD-like method, information about transitions is saved. For instance for main signal, Y₀, index i is incremented, and each sample, Y₀(i), is compared to previous sample, Y₀(i−1). If Y₀(i) is different from Y₀(i−1), Y₀(i) is saved. Then, index i is further incremented. Assume that all samples from Y₀(i+1) to Y₀(i+10) have same value as Y₀(i), but that Y₀(i+11) is different from Y₀(i), then number 10 is a main data related to main signal, Y₀, that is saved with Y₀(i) in step (iii).

Number 10 corresponds to an interval of the reference signal, X, during which main signal, Y₀, is constant and is named ‘constant interval’ in the following. Then, when the method of the invention is also able to access the useful information stored from the waveform data 100 for displaying it at a waveform viewer 200, it preferably processes as follows. When choosing among Y₀, and the different folded signals, Y_{f}, which one is better-adapted for display, the method of the invention preferably first determines a ‘real’ number of samples in said range, ΔX, of the reference signal, X. Said ‘real’ number can be determined from the constant interval. If main (or folded) signal, Y₀, is saved with a VCD-like method, real number is obtained by combining the number of saved data related to transitions and said ‘constant intervals’. The number of saved data related to transitions does indeed not correspond to the exact number of samples of Y₀. By taking into account the different ‘constant intervals’ during which main (or folded) signal, Y₀, is constant, one can determine an exact number of samples of the corresponding signal, and thereafter chose the one that is best-adapted for display, which means the one that has a number of samples that is closest to Nₚᵢₓ for instance.

According to another preferred embodiment, the generation of main signal, Y₀, is such that it comprises temporal information such as the one described in previous paragraph. Hence, the different folded signals, Y_{f}, also comprise such temporal information.

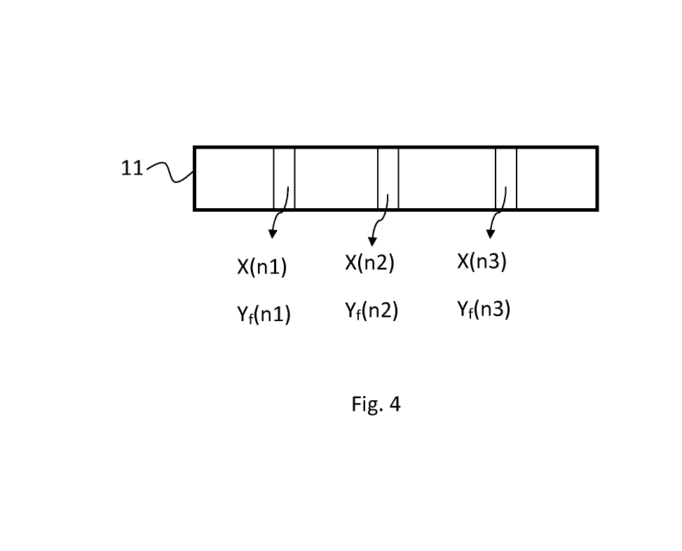

According to another preferred embodiment, the preferred main data file 10 comprises at least one element comprising an n-th value of said reference signal, X(n), and a value of a sample, Y₀(n), of said main signal at said n-th value of said reference signal, X. Preferably, the sub data file 11 comprises at least one element comprising an n-th value of said reference signal, X(n), and a value of a sample, Y_{f}(n), of the corresponding folded signal at said n-th value of said reference signal, X. More preferably, main data file 10 and all sub data files 11 are built in such a way. FIG. 4 illustrates a sub data file 11 that is built in this manner.

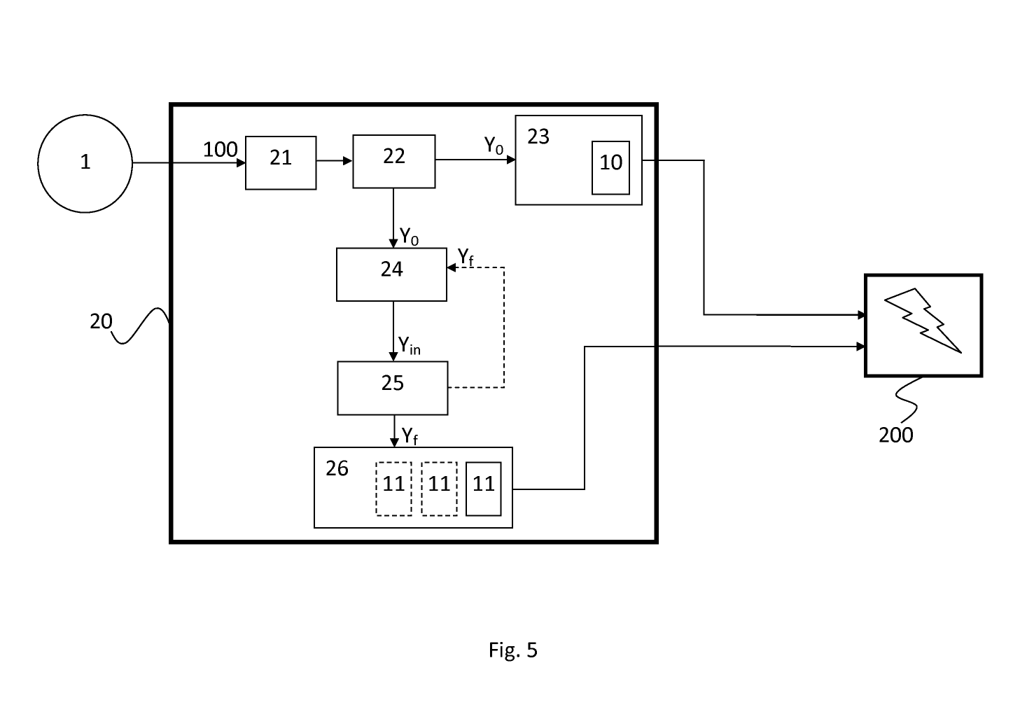

According to a second aspect, the invention relates to a device 20 (or system 20) for storing, from waveform data 100, useful information for a waveform viewer 200. The device 20 of the invention can take different forms or embodiments. Preferably, the device 20 is a computer or a computer unit. A personal computer can be used. FIG. 5 schematically illustrates a preferred embodiment of the device 20 of the invention in combination with a data source 1 and a waveform viewer 200.

The device 20 of the invention comprises input means 21 for receiving waveform data 100. Examples of input means 21 are acquisition board, USB interface, Ethernet interface. As shown in FIG. 5, waveform data 100 is preferably provided by a data source 1. Examples of data sources 1 have been given before. The device 20 of the invention also comprises processing means 22 for generating from this waveform data 100 one main signal Y₀ having N₀ samples: Y₀(i) i=1, . . . N₀. These N₀ samples are N₀ values of said main signal Y₀ at N₀ values of a reference signal, X. Examples of main signal, Y₀, and reference signal, X, have been provided before and apply here for the device 20 of the invention. Examples of processing means 22 are a processing unit or a calculation unit of a computer, embedded PC, mini computer, tablet, ASICs, FPGAs, DSPs, working station, SoC, ASSP. Preferably, processing means 22 is part of a sensor that collects waveform data 100.

The device 20 of the invention comprises saving means 23 for saving in a main data file 10 main data related to the main signal Y₀. Examples of saving means 23 are internal or portable hard disks, USB key, CD-ROM, another computer device in the cloud.

The device 20 of the invention comprises pre-processing means 24 for defining an input signal to fold Yᵢₙ, that is:
if no folded signal originating from said main signal Y₀ has been generated before, said main signal Y₀,
else, a folded signal originating from said main signal Y₀ that has been generated just before.
   Pre-processing means 24 and processing means 22 described above for generating from waveform data 100 one main signal Y₀ having N₀ samples can be identical. Examples of pre-processing means 24 are a processing unit or a calculation unit of a computer, ASICs, FPGAa, microcontrollers, DSPs.

Processing means 25 of the device 20 of the invention allow generating one or more folded signal Y_{f} that is a global reproduction of lower resolution of the input signal to fold, Yᵢₙ, that has N_{f} samples that are N_{f} values of said folded signal Y_{f} at N_{f} values of said reference signal, X, and that has less samples than said input signal to fold, Yᵢₙ. The generation of the folded signal Y_{f} by the processing means 25 is performed by carrying out the following steps:
a) applying to substantially the whole of said input signal to fold, Yᵢₙ, a folding algorithm such that:
   samples of said input signal to fold, Yᵢₙ, satisfying folding rules are selected;
   samples of said input signal to fold, Yᵢₙ, not satisfying said folding rules are deleted;
b) thereafter grouping the samples selected in step a) for forming said folded signal Y_{f};
   Pre-processing means 24, processing means 22 described above for generating from waveform data 100 one main signal Y₀ having N₀ samples, and processing means 25 described in this paragraph can be identical. Examples of processing means 25 are a processing unit or a calculation unit of a computer. All the preferred technical features described above with reference to step (v) of the method according to first aspect of the invention apply here mutatis mutandis. In particular, various folding algorithms can be used, for instance the three preferred folding algorithms described above with reference to step (v) of the method according to first aspect of the invention.

The device 20 of the invention also comprises saving means 26 for saving in a sub data file 11 sub data related to a folded signal, Y_{f}. The different examples for the main signal, Y₀, and for the folded signals, Y_{f}, that have been previously presented in relation to the method of the invention apply here for the device 20. Also, the different ways to build main 10 and sub 11 data files that have been previously presented in relation to the method of the invention apply here for the device 20. As a general remark, features described in relation to the method of the invention apply for the device 20 mutatis mutandis and when applicable.

Preferably, the pre-processing means 24, the processing means 25, and the saving means 26 are able to run iteratively in order to define successive input signals to fold, Yᵢₙ, in order to generate successive folded signals, Y_{f}, and in order to save such successive folded signals, Y_{f}, in different sub data files 11. Preferably, the device 20 then comprises a sub unit for detecting when a folded signal, Y_{f}, has a number of samples that is equal to a predetermined minimum value. Then, the device 20 is preferably able to stop the iteration process for stopping generating folded signals, Y_{f}.

Main data related to main signal, Y₀, and sub data related to folded signals, Y_{f}, respectively saved in main 10 and sub 11 data files can thereafter be used for displaying useful information at a waveform viewer 200. Generally, a waveform viewer 200 is located at a user station.

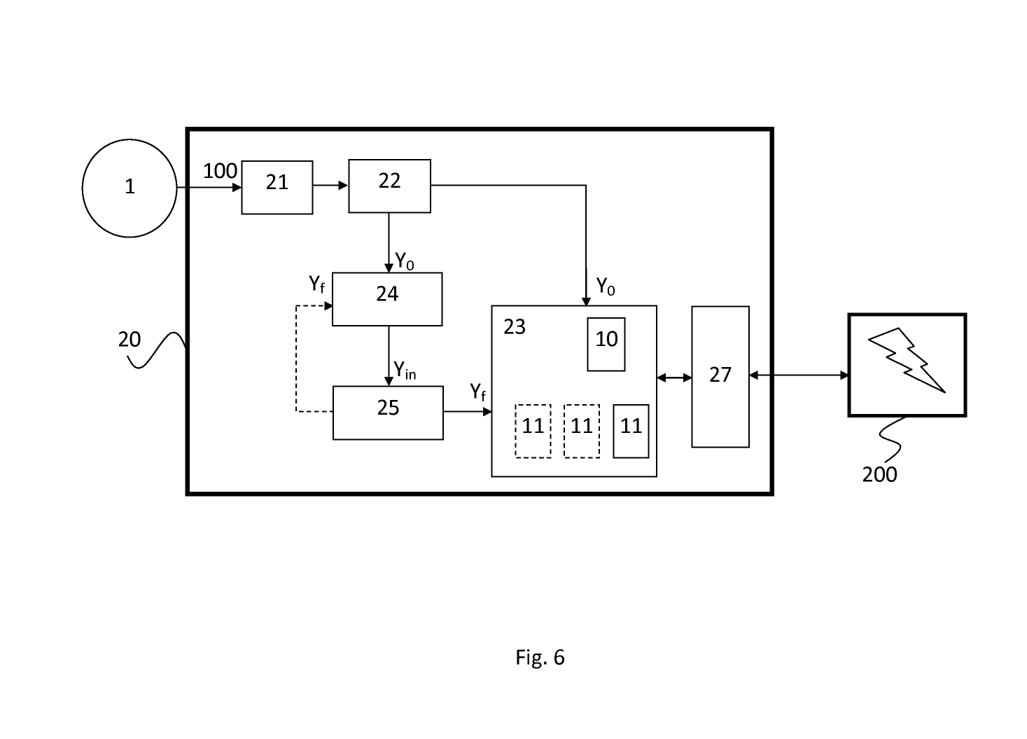

FIG. 6 shows another preferred embodiment of the device 20 of the invention also in combination with a data source 1 and a waveform viewer 200. In this preferred embodiment, same saving means 23 are used for saving main data related to the main signal, Y₀, in a main data file 10, and for saving sub data related to the folded signal(s), Y_{f}, in one or more sub data file(s) 11. This preferred device 20 comprises an accessing unit 27 for choosing among said main signal, Y₀, and among said folded signals, Y_{f}, one of them having in a range, ΔX, of said reference signal, X, a number of samples that is closest to a number of pixels, Nₚᵢₓ, available in a width of a display window of a waveform viewer 200 in said range, ΔX, of said reference signal X. Hence, according to this preferred embodiment, it is possible to easily access the signal that is the most adapted for the display window selected by a user. Such an easy access is notably possible thanks to the specific generations and savings of main, Y₀, and folded signals, Y_{f}. For choosing the most adapted signal among Y₀ and the different Y_{f}, accessing unit 27 has first to determine the number of samples in each of these signals, Y₀ and the different Y_{f}, in the range ΔX. The accessing unit 27 can then determine a difference value for each signal, Y₀ and the different Y_{f}, that is the difference between Nₚᵢₓ and the numbers of samples of each of these signals in the range ΔX. A signal with the smallest difference value is selected by the accessing unit 27. As the number of samples of the selected signal is not in general equal to Nₚᵢₓ, a processing step is in general thereafter applied in order to have a value of the selected signal at each pixel of the display window. Interpolation that is known by the one skilled in the art is preferably applied. When a compression algorithm is used for saving main and/or sub data in main 10 and sub 11 data files, decompression of them is preferably carried out prior determining a difference value for each signal, Y₀ and the different Y_{f}, that is the difference between Nₚᵢₓ and the number of samples of each of these signals in the range ΔX. Preferably, accessing unit 27 and processing means (22; 25) for generating main, Y₀, and folded signals, Y_{f}, are a same unit. Such a same unit can also corresponds to pre-processing means 24 for defining the input signal to fold, Yᵢₙ.

Preferably, folding algorithm is applied until the number of samples in a folded signal, Y_{f}, is equal to or lower than a threshold. Preferably, this threshold is equal to 1920. More preferably, this threshold is equal to 800. Still more preferably, this threshold is equal to 366.

Preferably, the folding algorithm is such that each folded signal, Y_{f}, comprises local snapshot information of main signal, Y₀.

Preferably, more than one main signal, Y₀, is generated in step (ii) of the method of the invention or by the processing means 22 of the device 20 of the invention. Then, different sets of folded signals, Y_{f}, are generated, one set for each main signal, Y₀.

The present invention has been described in terms of specific embodiments, which are illustrative of the invention and not to be construed as limiting. More generally, it will be appreciated by persons skilled in the art that the present invention is not limited by what has been particularly shown and/or described hereinabove. Reference numerals in the claims do not limit their protective scope. Use of the verbs “to comprise”, “to include”, “to be composed of”, or any other variant, as well as their respective conjugations, does not exclude the presence of elements other than those stated. Use of the article “a”, “an” or “the” preceding an element does not exclude the presence of a plurality of such elements.

The invention may also be described as follows. The method of the invention comprises the steps of: receiving waveform data 100; generating one main signal Y₀; saving main data related to main signal Y₀; defining an input signal to fold, Yᵢₙ, that is said main signal Y₀ or a folded signal that has been generated just before; generating a new folded signal, Y_{f}, that is a global reproduction of lower resolution of input signal to fold, Yᵢₙ, and that has less samples than the latter by following the steps of: applying to whole input signal to fold, Yᵢₙ, a folding algorithm such that: its samples satisfying folding rules are selected; its samples not satisfying said folding rules are deleted; thereafter grouping the selected samples for forming said new folded signal Y_{f}; saving sub data related to said folded signal Y_{f}. Hence, waveform storage is based on wrapper encoding at each successive folding level.

1. Method for storing, from waveform data (100), useful information for a waveform viewer (200) and comprising the steps of:
(i) receiving said waveform data (100);
(ii) generating from this waveform data (100) one main signal Y₀ having N₀ samples, Y₀(i) i=1, . . . N₀, that are N₀ values of said main signal Y₀ at N₀ values of a reference signal, X;
(iii) saving main at a related to said main signal Y₀;
(iv) defining an input signal to fold, Yᵢₙ, that is:
if no folded signal originating from said main signal Y₀ has been generated before, said maid signal Y₀,
else, a folded signal originating from said main signal Y₀ that has been generated just before;
(v) generating a folded signal V_{f}:
that is a global reproduction of lower resolution of said input signal to fold, Yᵢₙ,
that has N_{f} samples that are N_{f} values of said folded signal Y_{f} at N_{f} values of said reference signal, X, and
that has less samples than said input signal to fold, Yᵢₙ,
by carrying out the following steps:
a) applying to substantially the whole of said input signal to fold, Yᵢₙ, a folding algorithm such that:
samples of said input signal to fold, Vᵢₙ, satisfying folding rules are selected;
samples of said input signal to fold, Yᵢₙ, not satisfying said folding rules are deleted;
b) thereafter grouping the samples selected in step a) for forming said folded signal Y_{f};
(iv) saving sub data related to said folded signal Y_{f};
(vii) optionally repeating steps (iv) to (vi).

2. (canceled)

3. (canceled)

4. Method according to claim 1 wherein said N₀ samples of said main signal Y₀ represent amplitudes of a digital signal.

5. Method according to claim 1 wherein said N₀ samples of said main signal Y₀ represent amplitudes of an analog signal.

6. Method according to claim 1 wherein said main signal Y₀ represents a combination of signals comprised in said waveform data (100).

7. Method according to claim 1 wherein said main signal Y₀ is generated by using a transition detection method such that it mainly contains information about transitions.

8. Method according to claim 1 wherein said main data related to said main signal Y₀ is saved in step (iii) by using a method that records transitions.

9. Method according to claim 1 wherein said folding algorithm comprises the following steps;
dividing said input signal to fold, Yᵢₙ, in portions, each portion comprising substantially Nₚ successive samples of said input signal to fold, Yᵢₙ, Nₚ≧3;
for each of said portions applying the following steps for selecting two samples in each or said portions;
one sample whose absolute value is equal to or larger than the other samples is selected,
another sample whose absolute value is equal to or smaller than the other samples is selected, and
the other samples are deleted.

10. Method according claim 9 wherein said folding algorithm comprises the following steps:
dividing said input signal to fold, Yᵢₙ, in portions, each portion comprising substantially Nₚ successive samples of said input signal to fold, Yᵢₙ, Nₚ≧3;
for each of said portions applying the following steps for selecting two samples in each of said portions:
sample Yᵢₙ(q) with lowest index q is selected:
sample Yᵢₙ(p) with highest index p is selected;
the other samples are deleted.

11. Method according to claim 10 wherein said folding algorithm comprises the following steps:
dividing said input signal to fold, Yᵢₙ, in portions, each portion comprising substantially Nₚ successive samples of said input signal to fold, Yᵢₙ, Nₚ≧3;
for each of said portions applying the following steps for selecting one sample in each of said portions:
detecting if a transition occurs among the successive samples of the portion;
if yes, one sample Yᵢₙ(b) of the portion is selected, where b is neither the lowest nor the highest index in the portion, the other samples of the portion are deleted;
if no, no sample is selected.

12. Method according to claim 1 for also accessing said useful information for displaying it at a waveform viewer (200), and further comprising the steps of:
providing a range, ΔX, of said reference signal, X;
providing a width of a display window of said waveform viewer (200);
providing a number of pixels, Nₚᵢₓ, available for display in said width of said display window;
among said main signal, Y₀, and among said folded signals, Y_{f}, choosing one of them having in said range, ΔX, of said reference signal X, a number of samples closest to said number of pixels, Nₚᵢₓ.

13. Method according to claim 1 for also accessing said useful information for displaying it at a waveform viewer (200), and further comprising the steps of:
providing a range, ΔX, of said reference signal X;
providing a width of a display window of said waveform viewer (200);
providing a number of pixels, Nₚᵢₓ, available for display in said width of said display window;
among said main signal, Y₀, and among said folded signals, Y_{f}, choosing one of them having in said range, ΔX, of said reference signal, X, a number of samples equal to or larger than said number of pixels, Nₚᵢₓ.

14. Method according to claim 1 wherein said main data related to said main signal, Yᵢₙ, is saved in a main data file (10) in step (iii), said main data file (10) comprising at least one element comprising an n-th value of said reference signal, X(n), and a value of a sample, Y₀(n) of said main signal at said n-th value of said reference signal, X.

15. Method according to claim 1 wherein said sub data related to said folded signal, Y_{f}, is saved in a sub data file (11) in step (vi), said sub data file (11) comprising at least one element comprising an n-th value of said reference signal, X(n), and a value of a sample, Y_{f}(n) of said folded signal at said n-th value of said reference signal, X.

16. Device (20) for storing, from waveform data (100), useful information for a waveform viewer (200) and comprising:
input means (21) for receiving waveform data (100);
processing means (22) for generating from this waveform data (100) one main signal Y₀ having N₀ samples, Y₀(i) i=1, . . . N₀, that are N₀ values of said main signal Y₀ at N₀ values of a reference signal, X;
saving means (23) for saving main data related to said main signal Y₀;
pre-processing means (24; 22) for defining an input signal to fold Yᵢₙ, that is:
if no folded signal originating from said main signal Y₀ has been generated before, said main signal Y₀,
else, a folded signal originating from said main signal Y₀ and that has been generated just before;
processing means (25; 22) for carrying out the following steps:
a) applying to substantially the whole of said input signal to fold, Yᵢₙ, a folding algorithm such that:
samples of said input signal to fold, Yᵢₙ, satisfying folding rules are selected;
samples of said input signal to told, Yᵢₙ, not satisfying said folding rules are deleted;
b) thereafter grouping the samples selected in step a) for forming said folded signal Y_{f};
for generating a folded signal Y_{f}
that is a global reproduction of lower resolution of said input signal to fold, Yᵢₙ,
that has N_{f} samples that are N_{f} values of said folded signal V_{f} at N_{f} values of said reference signal, X, and
that has less samples than said input signal to fold, Yᵢₙ;
saving means (26; 23) for saving sub data related to said folded signal V_{f}.

17. Device (20) according to claim 16 wherein said pre-processing means (24), said processing means (25), and said saving means (26) are able to run iteratively in order to define successive input signals to fold, Yᵢₙ, in order to generate successive folded signals, Y_{f}, and in order to save such successive folded signals, V_{f}.

18. Device (20) according to claim 17 wherein said successive folded signals, Y_{f}, are saved in different sub data files (11).

19. Device (20) according to claim 17 further comprising an accessing unit (27) for choosing among said main signal, Y₀, and among said folded signals, Y_{f}, one of them having in a range, ΔX, of said reference signal, X, a number of samples that is closest to a number of pixels, Nₚᵢₓ, available in a width of a display window of a waveform viewer (200).

20. Device according to claim 17 wherein said main data related to said main signal Y₀ is saved in a main data file (10).

21. Method according to claim 7 wherein said folding algorithm comprises the following steps:
dividing said input signal to fold, Yᵢₙ, in portions, each portion comprising substantially Nₚ successive samples of said input signal to fold Yᵢₙ, Nₚ≧3;
for each of said portions applying the following steps for selecting two samples in each of said portions:
one sample whose absolute value is equal to or larger than the other samples is selected,
another sample whose absolute value is equal to or smaller than the other samples is selected, and
the other samples are deleted.

22. Method according to claim 8 wherein said folding algorithm comprises the following steps:
dividing said input signal to fold, Yᵢₙ, in portions, each portion comprising substantially Nₚ successive samples of said input signal to fold, Yᵢₙ, Nₚ≧3;
for each of said portions applying the following steps for selecting two samples in each of said portions:
one sample whose absolute value is equal to or larger than the other samples is selected,
another sample whose absolute value is equal to or smaller than the other samples is selected, and
the other samples are deleted.

23. Method according to claim 8 for also accessing said useful information for displaying it at a waveform viewer (200), and further comprising the steps of:
providing a range, ΔX of said reference signal X;
providing a width of a display window of said waveform viewer (200);
providing a number of pixels, Nₚᵢₓ, available for display in said width of said display window;
among said main signal, Y₀, and among said folded signals, Y_{f}, choosing one of them having in said range, ΔX, of said reference signal, X, a number of samples closest to said number of pixels, Nₚᵢₓ.

24. Method according to claim 8 for also accessing said useful information for displaying it at a waveform viewer (200), and further comprising the steps of:
providing a range, ΔX, of said reference signal, X;
providing a width of a display window of said waveform viewer (200);
providing a number of pixels, Nₚᵢₓ, available for display in said width of said display window;
among said main signal, Y₀, and among said folded signals, Y_{f}, choosing one of them having in said range, ΔX, of said reference signal X, a number of samples equal to or larger than said number of pixels, Nₚᵢₓ.
